(19) United States
(12) Patent Application Publication
(10) Pub. No.: US 2024/0024793 A1
(43) Pub. Date: Jan. 25, 2024

(54) Battery operated low rider ride on toys

(71) Applicants: Jimmy Lee Roark, Webbers Falls, OK (US); Pamela Jean Roark, Webbers Falls, OK (US)

(72) Inventors: Jimmy Lee Roark, Webbers Falls, OK (US); Pamela Jean Roark, Webbers Falls, OK (US)

(21) Appl. No.: 17/300,903

(22) Filed: Jul. 22, 2022

Related U.S. Application Data
(60) Provisional application No. 63/259,080, filed on Jun. 21, 2021.

(51) Int. Cl. A63H 17/26

(52) U.S. Cl. CPC A63H 17/262

(57) ABSTRACT

Battery-operated low rider chassis toy automobile design.

The present application claims benefit of Provisional Application No. 63/259,080, filed Jun. 21, 2021; all of which is incorporated by reference herein.

### BACKGROUND OF THE INVENTION

### Field of the Invention

The present invention relates to a battery-operated low rider ride on toys.

### Summary of the Invention

It is an object of the present invention to provide battery-operated low rider ride on toys.

These and other objects of the present invention will be apparent from review of the following specification and the accompanying drawings.

### BRIEF DESCRIPTION OF THE DRAWINGS

FIG. 1 is an isometric view of battery-operated low rider chassis toy automobile design;

FIG. 2 is a front elevational view of FIG. 1;

FIG. 3 is a rear elevational view of FIG. 1;

FIG. 4 is a left elevational view of FIG. 1;

FIG. 5 is a right side elevational view of FIG. 1;

FIG. 6 is a top plan view of FIG. 1; and

FIG. 7 is a bottom plan view of FIG. 1.

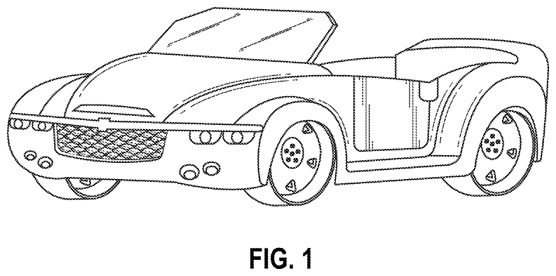

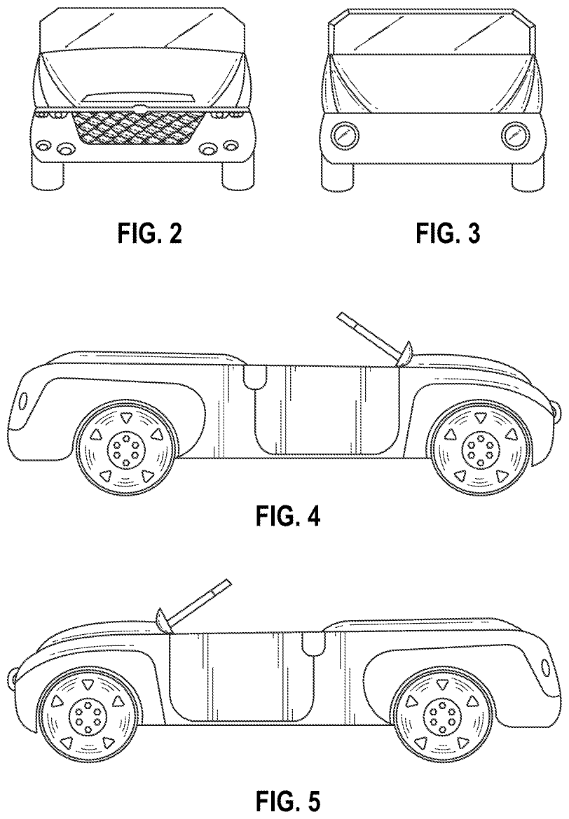

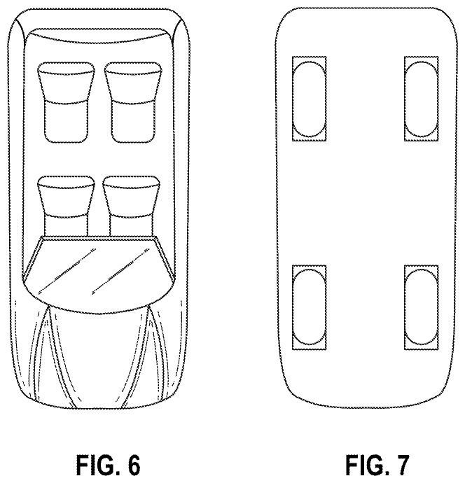

### DETAILED DESCRIPTION OF THE PREFERRED EMBODIMENT

The present subject matter discloses battery-operated low rider ride on toys.

Embodiments of the invention will be apparent to those skilled in the art from consideration of the specification and practice of the invention disclosed herein. It is intended that the specification and examples be considered as exemplary only, with a true scope and spirit of the invention being indicated by the following claims.

We claim:

1. The battery-operated low rider ride on toys as shown and described.
